(19) United States
(12) Patent Application Publication
(10) Pub. No.: US 2003/0037183 A1
(43) Pub. Date: Feb. 20, 2003

(54) System for standardized mainframe connection and method for connecting with a mainframe

(76) Inventors: Tony Hashem, Lynchburg, VA (US); Riad Hasan, Forest, VA (US); Ashwin Parmar, Lynchburg, VA (US)

Correspondence Address: Kerry H. Owens, Hunton & Williams, Suite 1200, 1900 K Street, N.W., Washington, DC, 20006, US

(21) Appl. No.: 09/930,972

(22) Filed: Aug. 17, 2001

(51) Int. Cl. G06F 9/46

(52) U.S. Cl. 709/328; 709/320

(57) ABSTRACT

A mainframe connection system usable with multiple software applications is provided. The mainframe connection system operates between a client device, a server, and a mainframe computer. The mainframe connection system includes a set of client tools residing on the client device. The client tools comprise mainframe connection tools for creating a reference to a server object on the server, messaging tools for requesting a connection and sending a request string, and access tools for accessing a result stored on the server. A set of server tools residing on the server comprises interfacing tools for utilizing a server object for sending the request string to the mainframe computer and receiving a response from the mainframe computer, and server storage means for storing a result received from the mainframe computer. A set of mainframe tools comprises a main controller for receiving and interpreting the request string and selecting a program for obtaining a result, and result transmission tools for transmitting the result to the server for storage by the server storage means. A corresponding method connects the client device with the mainframe computer.

### FIELD OF THE INVENTION

The invention is related to the field of connecting to a mainframe and more particularly to a method and system adaptable to multiple software packages for sending commands and receiving responses from a mainframe.

### BACKGROUND OF THE INVENTION

In recent years, it has become common practice to store large quantities of information on a mainframe computer. Mainframe computers are capable of supporting hundreds or thousands of users simultaneously and are often used to store customer records that must be frequently accessed by the client.

Accordingly, it is often necessary for users of different software programs to access the stored information in order to use the information in their applications. In order to talk to a mainframe session, client software must be installed on a client device. This client software provides the connectivity to the mainframe computer. In order to provide connectivity between the software and the mainframe computer, a customized software installation is generally required. The development of software and mainframe connection logic for each application can be both time-consuming and expensive.

Therefore, a system is needed that is easily adaptable to connect multiple software packages to enable communication with a mainframe system.

### SUMMARY OF THE INVENTION

In accordance with the purposes of the invention as embodied and broadly described herein, there is provided a mainframe connection system usable with multiple software applications. The mainframe connection system operates between a client device, a server, and a mainframe computer and comprises a set of client tools residing on the client device. The client tools comprise mainframe connection tools for creating a reference to a server object on the server, messaging tools for requesting a connection and sending a request string, and result extraction tools for accessing a result stored on the server. A set of server tools resides on the server and comprises interfacing tools for utilizing a server object for sending the request string to the mainframe computer and receiving a response from the mainframe computer, and a server storage mechanism for storing a result received from the mainframe computer. A set of mainframe tools comprises a main controller for receiving and interpreting the request string and selecting a program for obtaining the result, and result transmission means for transmitting the result to the server for storage by the server storage mechanism.

In another aspect of the invention, a method is provided for connecting a client device with a mainframe computer while using a software application. The method is usable with multiple software applications. The method comprises the steps of using a client device to create a reference to a server object on a server, implementing a connection-to-mainframe routine on the client device in order to pass a request string to the server object, and sending the request string from the server to the mainframe. The mainframe computer performs the steps of receiving and interpreting the request string at the mainframe, calling an appropriate mainframe program based on the interpretation, obtaining a result using the appropriate mainframe program, and sending the result to the server. The server performs the step of storing the result at the server as a local result object. The client device performs the step of retrieving the result from the server object on the server.

These and other features, objects, and advantages of the preferred embodiments will become apparent when the detailed description of the preferred embodiments is read in conjunction with the drawings attached hereto.

### BRIEF DESCRIPTION OF THE DRAWINGS

FIG. 1 is a block diagram illustrating an embodiment of the system for connecting with a mainframe.

FIG. 2 is a block diagram illustrating an embodiment of a client device of the invention.

FIG. 3 is a block diagram illustrating an embodiment of a server of the invention.

FIG. 4 is a block diagram showing an embodiment of the mainframe computer of the invention.

FIG. 5 is a flow chart showing an embodiment of a method performed by a system of the invention.

### DETAILED DESCRIPTION OF PREFERRED EMBODIMENTS

Reference will now be made in detail to the present preferred embodiments of the invention, examples of which are illustrated in the accompanying drawings in which like reference numerals refer to corresponding elements.

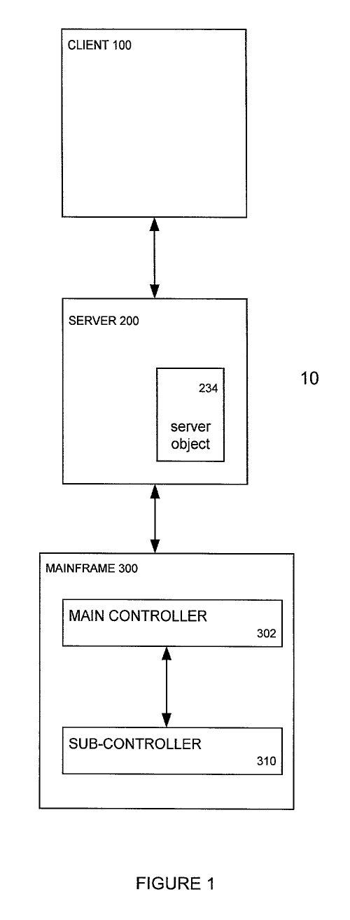

FIG. 1 is a block diagram illustrating components of the mainframe connection system 10 of the invention. The mainframe connection system 10 operates on and between a client device 100, a server 200 and a mainframe computer 300.

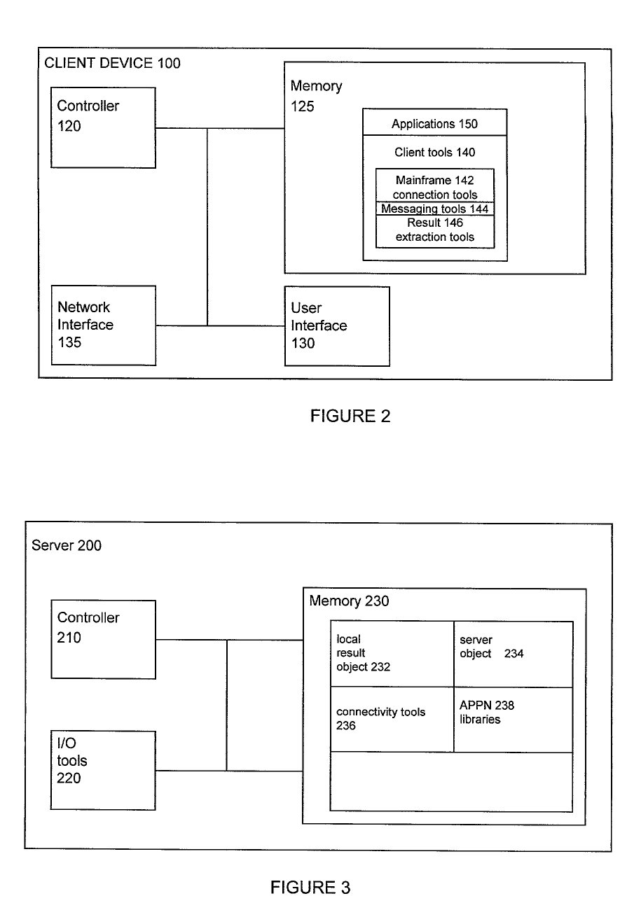

In an embodiment of the invention, as shown in FIG. 2, the client device 100 includes a controller 120, a memory 125, a user interface 130, and a network interface 135. The client device 100 may communicate over a network (not shown) with the server 200 and the mainframe computer 400.

The client device 100 may take any known form, such as a personal computer running the Microsoft Windows™ 95, 98, Millenium™, NT™, or 2000, WindowsTMCE™, PalmOS™, Unix, Linux, Solaris™, OS/2™, BeOS™, MacOS ™ or other operating system or platform.

The network may be, include or interface to any one or more of, for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. The communications link may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. Communication may also be accomplished by any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection.

The controller 120 may include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control.

The memory 125 may include electronic memory such as RAM (random access memory) or EPROM (electronically programmable read only memory), storage such as a harddrive, CDROM or rewritable CDROM or other magnetic, optical or other media, and other associated components connected over an electronic bus, as will be appreciated by persons skilled in the art.

The network interface 135 may be or include a network-enabled appliance such as a WebTVTM unit, radio-enabled Palm™ Pilot or similar unit, a browser-equipped cellular telephone, or other TCP/IP client or other device. The user interface 130 may include any known device such as a mouse, monitor, and/or keypad.

Software applications 150 may be stored in the memory 125 and may use a set of client tools 140 to connect to the mainframe computer 300. The set of client tools 140 for facilitating mainframe communications preferably includes mainframe connection tools 142 for creating a reference to a server object on the server 200 and requesting connection to the mainframe computer 300. The client tools 140 preferably also include messaging tools 144 and result extraction tools 146. The messaging tools 144 pass a request string to the server 200 so that the server 200 will obtain a result from the mainframe computer 300. Once the server 200 obtains the result, the result extraction tools 146 may retrieve the result from the server 200.

The client tools 140 may interact with the server 200 and be implemented as servlets and java server pages. “Servlet” generally refers to a Java applet (a program designed to be executed from within another application) that runs within a web server environment. This is analogous to a Java applet that runs within a web browser environment.

Java servlets provide an alternative to CGI programs. Once a java servlet is started, it stays in memory and can fulfill multiple requests. In contrast, a CGI program disappears once it has fulfilled a request. The persistence of Java servlets makes them faster because there's no wasted time in setting up and tearing down the process.

Web browsers, which are often equipped with Java virtual machines, can interpret servlets. Because servlets are small in files size, cross-platform compatible, and highly secure, they are ideal for small Internet applications accessible from a browser.

The server 200 may be computer or device on a network that manages network resources. Servers are often dedicated, meaning that they perform no other tasks besides their server tasks. On multiprocessing operating systems, however, a single computer can execute several programs at once. A server in this case could refer to the program that is managing resources rather than an entire computer.

In an embodiment of the invention, the server 200 may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform.

In an embodiment of the invention, the server 200 includes a controller 210, which is substantially similar to the controller 110 described above and a memory 230 having any one or more of the configurations described above with respect to the memory 125 on the client device 100. The server 200 may further include I/O tools 220 for receiving and transmitting information. In the memory 230, the server 200 may store a server object 234, a local result object 232, connectivity tools 236 such as View Manager™, and APPN libraries 238.

The server 200 may use a SERVLET or a JAVA Remote Method Invocation (RMI) and Java Native Interface (JNI) technology to create the server object 234. RMI is a set of protocols that enables Java objects to communicate remotely with other Java objects. RMI is a relatively simple protocol, but unlike more complex protocols, it works only with Java objects. JNI is a JAVA programming interface, or application program interface (API), that allows developers to access the languages of a host system and determine the way JAVA integrates with native code.

The server may create a SERVLET that connects to the mainframe 300 or use RMI and JNI technology to create the server object 234 that connects to the mainframe 300 and is capable of sending requests and receiving a response back form the mainframe. Upon receiving a request string from the client device 100, the server object 234 connects to the mainframe computer 300 using the connectivity tools 236, which then uses APPN libraries 238. If the server 200 receives a result from the mainframe computer 300, the server 200 stores the result as the local result object 232 for subsequent retrieval by the client device 100.

The server object 234 then sends the request to the mainframe computer 300, which may receive the request in the online Customer Information Control System, (CICS), which is a transaction processing monitor from IBM that was originally developed to provide transaction processing for IBM mainframes. It controls the interaction between applications and users and lets programmers develop screen displays without detailed knowledge of the terminals being used. The server object 234 waits for the mainframe computer 300 to return a response. Upon receiving a response, the server 200 stores the result in the local result object 232, which the client device 100 accesses to obtain the result.

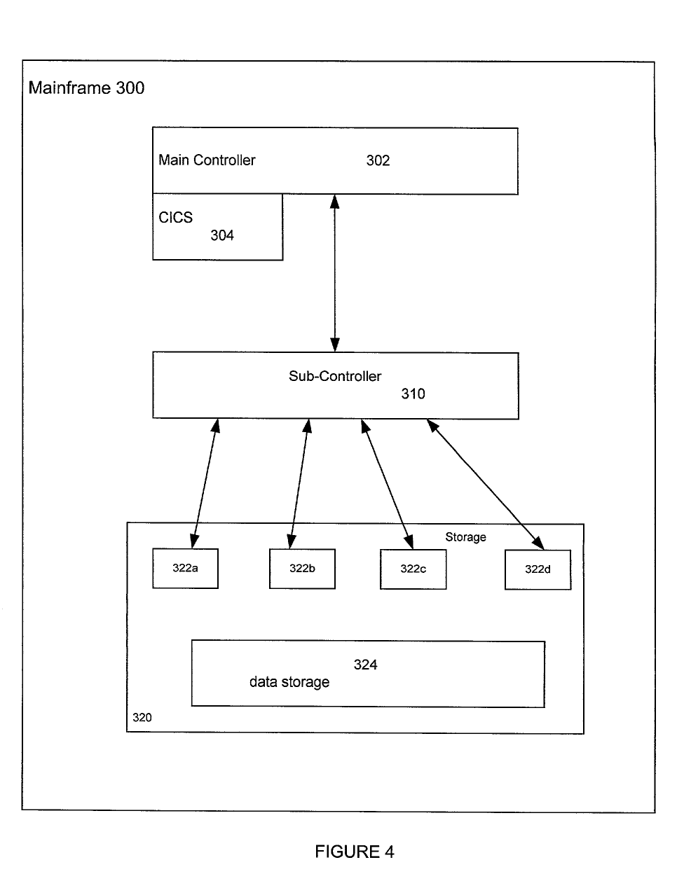

FIG. 4 shows the structure of an embodiment of the mainframe computer 300. The mainframe computer 300 comprises a main controller 302, CICS 304, a sub-controller 310 and a storage area 320. The storage area 320 may include a plurality of programs 322 a . . . n and data storage 324.

In operation, the main controller 302 accepts a message string from the server 200 and interprets the message string to determine a next course of action. Depending on the determination of the main controller 302, the request might be passed to the sub-controller 310 or may be processed directly by a program selected by the main controller 302. After receiving the result, the main controller 302 passes the result back to the server 200 for retrieval by the client.

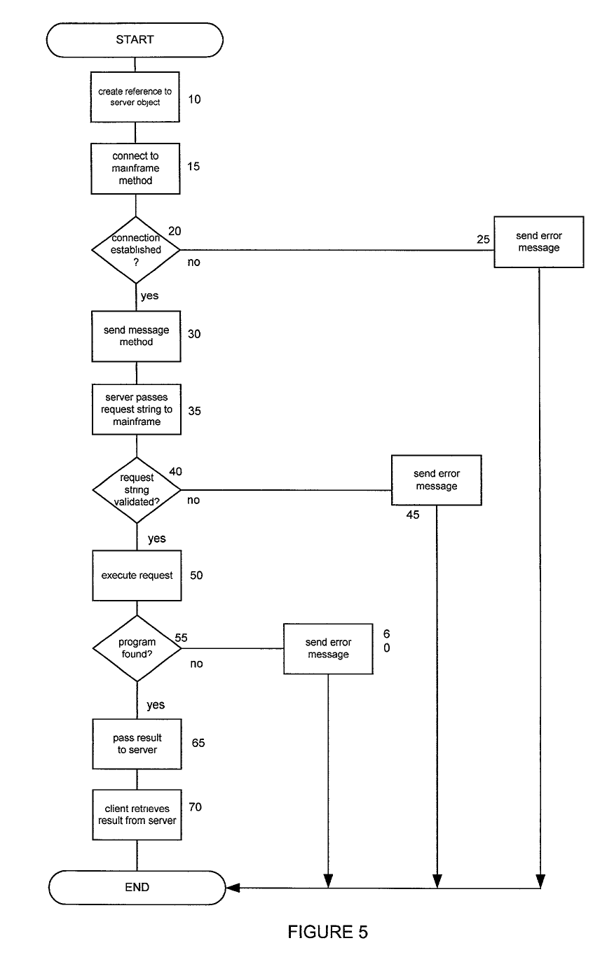

FIG. 5 illustrates a method for connection with a mainframe computer according to an embodiment of the invention. In step 10, the client 100 creates a reference to the server object 234. In step 15, the client 100 utilizes its mainframe connection tools 142 to call a connect-to-mainframe method.

In step 20, if the connect-to-mainframe method is not successful, the server 200 passes an error message back to the client 100 in step 25. If in step 20, the connect-to-mainframe method is successful, the client 100 passes the request string to the server object 234 by calling a send message method implemented by the messaging tools 144 in step 30. In step 35, the server passes the request string to the mainframe. If in step 40, the main controller on the mainframe fails to validate the request string, the main controller sends an error message back to the client in step 45. If in step 40, the main controller validates the request string, the main controller executes the request in step 50.

Execution of the request in step 50 depends upon the request itself. As one option, the main controller 302 may pass the request to the subcontroller 310 to find a proper program for executing the request. Alternatively, the main controller 302 may directly obtain the result or locate a program for obtaining the result.

If in step 55, the main controller 302 was unable to locate an appropriate program, the main controller 302 passes an error message back to the client 100 in step 60. If the main controller 302 does locate the appropriate program and produces a result, the main controller 302 passes the result back to the server 200 in step 65 and store it as a local result object 232.

In step 70, using result extraction tools 146, the client 100 can retrieve the result from the server 200.

In an embodiment of the invention, the request string contains a plurality of characters. The first four characters represent a “request ID” and indicate the nature of the request. The main controller 302 determines a next course of action based on the request ID. The request ID may indicate the type of search the client wants to conduct. In an embodiment of the invention, three different search types are available including an Alpha search type 1, an Alpha search type 2, and a pending policy search.

The programs 322a, 322b, and 322c may perform the aforementioned searches and return the results to the main controller 302. The result is sent as a response string. The first four characters of the response string comprise a return code. A non-zero value of the return code indicates an error. The rest of the response string includes the requested policy data.

A client may institute a search at client device 100 for a policy number such as 1234567890 and a company code such as 02 on a pending file on the mainframe computer 300. The system 10 will follow the steps described above to retrieve data such as first name, last name, date of birth and social security number, etc. Other common tasks include looking up account balances and updating customer addresses.

In summary, a method and system for connecting with a mainframe computer in a simple and efficient manner are disclosed. The computer described as a mainframe computer for purposes of this application could encompass any type of computer. The invention is further applicable to computers other than mainframe computers. The connection system and method can be used for any type of transaction including XML transactions.

It will be apparent to those skilled in the art that various modifications and variations can be made in the system and method of the present invention without departing from the spirit and scope of the invention. Thus, it is intended that the present invention cover the modifications and variations of this invention provided that they come within the scope of the appended claims and their equivalents.

What is claimed is:

1. A mainframe connection system usable with multiple software applications, the mainframe connection system operating between a client device, a server, and a mainframe computer and comprising:
a set of client tools residing on the client device, the client tools comprising mainframe connection tools including means for creating a reference to a server object on the server, messaging tools for requesting a connection and sending a request string, and access tools for accessing a result stored on the server;
a set of server tools residing on the server and comprising interfacing means for utilizing a server object for sending the request string to the mainframe computer and receiving a response from the mainframe computer, and server storage means for storing a result received from the mainframe computer;
a set of mainframe tools comprising a main controller for receiving and interpreting the request string and selecting a program for obtaining a result, and result transmission means for transmitting the result to the server for storage by the server storage means.

2. The mainframe connection system of claim 1, wherein the set of client tools, comprises a JAVA class.

3. The mainframe connection system of claim 1, wherein the request string comprises an identifier for identifying a result to be obtained by the mainframe computer.

4. The mainframe connection system of claim 3, wherein the identifier identifies one of a plurality of searches for obtaining policy data.

5. The mainframe connection system of claim 1, wherein the set of mainframe tools further comprises a subcontroller for delegating a task assigned by the main controller.

6. The mainframe connection system of claim 1, wherein the result is embedded in a response string.

7. The mainframe connection system of claim 6, wherein a set of characters from the response string comprises a return code and a non-zero value of the return code indicates an error.

8. The mainframe connection system of claim 7, wherein the return code comprises a set of characters including the first four characters of the response string.

9. The mainframe connection system of claim 1, wherein the server storage means stores the result as a local result object.

10. A method for connecting a client device with a mainframe computer while using a software application, the method being usable with multiple software applications and comprising the steps of:
using a client computer to create a reference to a server object on a server;
implementing a connection-to-mainframe routine on the client device in order to pass a request string to the server object;
sending the request string from the server to the mainframe;
receiving and interpreting the request string at the mainframe;
calling an appropriate mainframe program based on the interpretation;
obtaining a result using the appropriate mainframe program;
sending the result to the server;
storing the result at the server as a local result object; and
retrieving the result from the server object with the client computer.

11. The method of claim 10, wherein the step of using a client computer to create a reference to a server object comprises using a JAVA class.

12. The method of claim 10, wherein the step of sending the request string comprises sending an identifier for identifying a result to be obtained by the mainframe computer.

13. The method of claim 12, wherein the identifier identifies one of a plurality of searches for obtaining policy data.

14. The method of claim 10, wherein the step of calling an appropriate mainframe program comprises sending the request from a main controller to a sub-controller.

15. The method of claim 10, wherein sending the response string comprises sending a set of characters including a return code, wherein a non-zero return code indicates an error.

16. The method of claim 15, wherein ending the response string comprises sending a set of characters including a return code, wherein a non-zero return code indicates an error.

17. The method of claim 16, wherein sending the set of characters including a return code comprises sending the first four characters as a return code.

18. The method of claim 10, further comprising the step of sending an error message from the mainframe computer if the mainframe computer cannot interpret the request or locate an appropriate program.
